(19) United States
(12) Patent Application Publication
(10) Pub. No.: US 2023/0393322 A1
(43) Pub. Date: Dec. 7, 2023

(54) LIGHTGUIDE WITH IMAGE-FORMING DIFFRACTIVE IN-COUPLER

(71) Applicant: Meta Platforms Technologies, LLC, Menlo Park, CA (US)

(72) Inventors: Xiayu Feng, Kirkland, WA (US); Zhexin Zhao, Kirkland, WA (US); Xuan Wang, Kirkland, WA (US); Hekun Huang, Redmond, WA (US); Gang Li, Seattle (JS); Lu Lu, Kirkland, WA (US)

(21) Appl. No.: 17/834,760

(22) Filed: Jun. 7, 2022

(51) Int. Cl. F21V 8/00; G02B 27/42; G02B 5/32; G02B 27/01

(52) U.S. Cl. CPC G02B 6/0023; G02B 27/4222; G02B 6/005; G02B 5/32; G02B 27/0172

(57) ABSTRACT

A display apparatus includes a lightguide for conveying images to an eyebox. The lightguide includes a substrate, a diffractive optical element (DOE) configured to couple the image light into the substrate. The DOE has a spatially variable pitch configured to provide the DOE with a positive optical power. The lightguide further includes a grating out-coupler supported by the substrate for out-coupling portions of the image light from the substrate toward the eyebox.

### TECHNICAL FIELD

The present disclosure relates to visual display devices and related components, modules, and methods.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such as near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images (CGIs)) superimposed with the surrounding environment by seeing through a “combiner” component. The combiner of a wearable display is typically transparent to external light but includes some light routing optic to direct the display light into the user's field of view.

Because a display of HMD or NED is usually worn on the head of a user, a large, bulky, unbalanced, and/or heavy display device with a heavy battery would be cumbersome and uncomfortable for the user to wear. Consequently, head-mounted display devices can benefit from a compact and efficient configuration, including efficient light sources and illuminators providing illumination of a display panel, high-throughput combiner components, ocular lenses, and other optical elements in the image forming train.

### BRIEF DESCRIPTION OF THE DRAWINGS

Exemplary embodiments will now be described in conjunction with the drawings, which are not to scale, in which like elements are indicated with like reference numerals, and in which:

FIG. 1 is a schematic side cross-sectional view of a display apparatus including a pupil replicating lightguide having a diffractive optical element (DOE) with a spatially variable pitch (SVP-DOE) as an in-coupler;

FIG. 2 is a schematic conceptual view of projecting image light through an eye pupil;

FIG. 3A is a schematic diagram illustrating light propagation in an output portion of a lightguide with a uniform-pitch grating in-coupler;

FIG. 3B is a schematic diagram illustrating light propagation in an output portion of a lightguide with an image-forming in-coupling DOE having a spatially varying pitch;

FIG. 3C is a schematic diagram illustrating light propagation in an input portion of the lightguide with the uniform-pitch grating in-coupler;

FIG. 3D is a schematic diagram illustrating light propagation in an input portion of the lightguide with the grating in-coupler having a spatially varying pitch;

FIG. 4A is a schematic diagram of a scanning projection display that can be used as a source of image light in the display apparatus of FIG. 1;

FIG. 4B is a schematic diagram of a pixelated display that can be used as a source of image light in the display apparatus of FIG. 1;

FIG. 5 is a schematic side cross-sectional view of an embodiment of the display apparatus of FIG. 1 with a wavefront pre-compensation device;

FIG. 6 is a schematic side cross-sectional view of an embodiment of the display apparatus of FIG. 1 with two out-coupling gratings for field of view (FOV) multiplexing;

FIG. 7 is a schematic side cross-sectional view of a curved lens element with an integrated pupil replicating lightguide having an SVP-DOE for use in an augmented reality (AR) display apparatus;

FIG. 8 is a schematic side cross-sectional view of a curved lens element integrating two pupil replicating lightguides for use in an AR display apparatus;

FIG. 9 is a 3D view of a display apparatus of FIG. 1 with a downwards emitting image projector;

FIG. 10 is a view of an AR display of this disclosure having a form factor of a pair of eyeglasses; and

FIG. 11 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

A term “eyebox” as used herein means a geometrical area for the user's eye where a good-quality image may be observed by a user of the NED. The term “eyebox” refers to a viewing area, i.e. a spatial region where a user's eye may be located for a satisfactory image quality, typically near an output region of the lightguide for embodiments described herein. In the context of this specification, the terms “viewing area” and “eyebox” are used interchangeably. A term “diffraction efficiency” as used herein refers to aspects of the performance of a diffractive optical element, e.g. a diffraction grating, in terms of power throughput of the diffraction grating. In particular, the diffraction efficiency can be a measure of the optical power diffracted into a given direction compared to the power incident onto the diffractive element. In examples described herein, the diffraction efficiency is typically a measure of the optical power diffracted by the grating or a segment thereof in the first order of diffraction relative to the power incident onto the grating or the segment thereof. A term “output efficiency” as used herein refers to a fraction of the optical power of a light source of a display apparatus that is available to the user for viewing images. Terms “grating pitch” and “grating period” are used herein interchangeably.

An aspect of the present disclosure relates to a display system comprising a pupil replicating lightguide configured to convey images to a viewing area or eyebox. The lightguide is configured to receive image light emitted by an image light source and to convey the image light to the eyebox for presenting to a user in an angular domain within a field-of-view (FOV) of the display. The term “field of view”, when used in relation to a display system, may refer to an angular range of light propagation supported by the system or visible to the user. A two-dimensional (2D) FOV may be defined by angular ranges in two orthogonal planes. For example, a 2D FOV of a NED device may be defined by two one-dimensional (1D) FOVs, which may be a vertical FOV, for example +\−20° relative to a horizontal plane, and a horizontal FOV, for example +\−30° relative to the vertical plane. With respect to a FOV of a NED, the “vertical” and “horizontal” planes or directions may be defined relative to the head of a standing person wearing the NED. Otherwise the terms “vertical” and “horizontal” may be used in the present disclosure with reference to two orthogonal planes of an optical system or device being described, without implying any particular relationship to the environment in which the optical system or device is used, or any particular orientation thereof to the environment.

AR and VR displays may use pupil-replicating lightguides to carry images to an eyebox and/or to illuminate display panels that generate images to be displayed. A pupil-replicating lightguide may include grating structures for in-coupling a light beam into the lightguide, and/or for out-coupling portions of the light beam along the waveguide surface. In accordance with this disclosure, a grating structure of a pupil-replicating lightguide may include an in-coupling diffractive optical element with a spatially variable grating pitch or grating period, a spatially variable blazing angle, etc.

Embodiments described herein relate to a pupil-replicating lightguide operable to project an image into an eye pupil of a viewer (“user”) at a plurality of positions of a viewer's eye within an eyebox of the display system. Such pupil-replicating projection lightguides may include an input diffractive optical element (DOE) with a spatially variable pitch (SVP), which may be referred to herein as SVP-DOE. Typically, e.g. for a NED or a heads-up display, having a large eyebox is advantageous as it allows accommodating users with different interpupillary distance, and generally relaxes many requirements on the display and the positioning of the user's head relative to the display. Supporting a large eyebox however in a conventional lightguide-based NED having uniform-pitch in-coupling and out-coupling gratings may require a large-area out-coupler, e.g. a large-area out-coupling (“output”) grating, with only a small portion of out-coupled light actually reaching the user's eye pupil for any specific eye position within the eyebox. Projecting or focusing the image light into the eye pupil of the user at a plurality of positions may enable increasing the lightguide throughput as compared to a traditional pupil-replicating lightguide, and thus making the image appear brighter for the viewer.

Accordingly, an aspect of the present disclosure provides a display apparatus comprising a lightguide for relaying image light to an eyebox, the lightguide comprising a substrate, an in-coupler, and an out-coupler integral with the substrate, the in-coupler comprising a diffractive optical element (DOE) having a spatially variable pitch (SVP). In some implementations, the DOE may comprise a holographic optical element (HOE). In some implementations, the DOE may be configured to have a positive optical power. In some implementations, the DOE may be configured to function as an off-axis optical lens.

An aspect of the present disclosure provides a lightguide for a display apparatus, the lightguide comprising: a substrate for relaying image light to an eyebox; an input diffractive optical element (DOE) configured to couple the image light into the substrate, the input DOE having a spatially variable pitch to provide the DOE with a non-zero optical power; and a grating out-coupler supported by the substrate for out-coupling portions of the image light from the substrate toward the eyebox. The substrate may comprise two opposing surfaces for guiding the image light within the substrate by total internal reflection (TIR) from the surfaces. In some implementations, the input DOE may be disposed at one of the two opposing surfaces, and may be configured so as not to diffract rays of in-coupled image light that are incident thereon after a TIR at the other one of the two opposing surfaces.

In some implementations, the input DOE comprises a holographic optical element (HOE) having a positive optical power. In some these or other implementations, the HOE may be configured to operate as a focusing lens. In any of these implementations, the HOE may be configured to operate as an off-axis lens. In any of the above implementations, the HOE may be configured to transmit therethrough, substantially without diffraction, light incident thereon at angles outside an angular acceptance range of the input DOE. The angular acceptance range of the input DOE may be outside of an angular range of TIR at the opposing surfaces of the substrate.

In any of the above implementations, the grating out-coupler may comprise a first optical diffraction grating (ODG). In at least some of such implementations, the input DOE and the first ODG may be disposed along the two opposing surfaces with an overlap. In at least some of such implementations, the first ODG may have a constant grating pitch. In at least some of such implementations, the grating out-coupler comprises a second ODG, with the first and second ODGs having opposite slant angles.

In any of the above implementations of the lightguide, the input DOE may have a positive optical power.

A further aspect of the present disclosure provides a display apparatus comprising: a first lightguide comprising a substrate for relaying image light to a viewing area; an input diffractive optical element (DOE) configured to couple the image light into the lightguide, the input DOE having a spatially variable pitch to provide the DOE with a positive optical power; and a grating out-coupler supported by the substrate for out-coupling the image light from the substrate toward the viewing area.

In some implementations, the display apparatus may comprise a curved shell substrate of an optically transparent material, the curved shell substrate comprising the first lightguide including the input DOE and the grating out-coupler. In some of such implementations, the first lightguide may be disposed in a cavity within the curved shell substrate with gaps between opposing surfaces of the substrate and the material of the shell. In some of such implementations, the display apparatus may comprise a second lightguide disposed within the curved shell substrate and comprising a substrate, an input DOE, and a diffractive out-coupler, wherein the substrates of the first and second lightguides are an angle to each other.

In any of the above implementations, the display apparatus may comprise an image projector for directing the image light toward the input DOE, the image projector disposed at a top portion of the substrate when the display apparatus is in use by a standing person.

In any of the above implementations of the display apparatus, the grating out-coupler may comprise a diffraction grating having a substantially constant grating pitch.

A further aspect of the present disclosure provides a lightguide for a display apparatus, the lightguide comprising: a substrate for relaying image light to an eyebox; an input diffractive optical element (DOE) configured to couple the image light into the substrate, the input DOE having a spatially variable pitch; and a diffractive out-coupler supported by the substrate for out-coupling portions of the image light from the substrate toward the eyebox, the diffractive out-coupler comprising an optical diffraction grating having a substantially constant grating pitch. In any of the above implementations of the lightguide, the DOE may be configured to have a positive optical power.

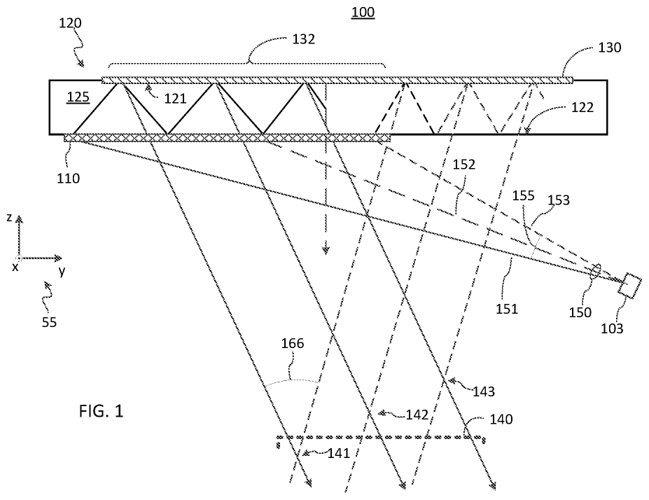

FIG. 1 illustrates an example display apparatus 100 for presenting images to a user. The display apparatus 100 may include an image projector 103 optically coupled to a lightguide 120 by a DOE 110 operating as an in-coupler. The image projector 103 is configured to provide image light 150 carrying the images in angular domain within an acceptance angle 155 of the DOE 110. In some embodiments the image light 150 may be polarized. The acceptance angle 155 is bound by edge rays 151 and 153 in the plane of the figure, and may also be referred to herein as an angular acceptance range of the DOE, or as input field of view (FOV) of the lightguide. The acceptance angle 155 may represent a one-dimensional (1D) cross-section of an input 2D FOV of the display apparatus 100. The lightguide 120 includes a substrate 125 and an output diffraction grating (ODG) 130 operating as an out-coupler. The ODG 130 may also be referred to herein as a grating out-coupler. The lightguide 120 relays the image light 150 to an eyebox 140 of the display apparatus 100. The ODG 130 may be disposed in or upon the substrate 125 extending across an output region thereof facing the eyebox 140.

The substrate 125, which may be e.g. a slab of a material that is transparent to visible light and may include one or more layers, has two opposing surfaces 121 and 122, e.g. the main outer surfaces of the substrate. The substrate 125 is configured for guiding the image light 150 within the substrate in a zig-zag fashion by reflections from the surfaces 121 and 122. In the illustrated embodiment the surfaces 121 and 122 are parallel to each other and to the (x,y) plane of a Cartesian coordinate system (x,y,z) 55. The z-axis direction is generally orthogonal to the surfaces 121 and 122.

The DOE 110 is configured to couple rays of the image light 150 spanning the acceptance angle 155 into the substrate 125, so that the in-coupled light impinges the surfaces 121, 122 at angles of incidence exceeding a critical angle of total internal reflection (TIR) at the surfaces 121, 122. The DOE 110 has a spatially variable grating pitch, i.e. the grating pitch that varies along the surfaces 121 or 122, e.g. along the y-axis of the coordinate system 55. In some embodiments, the pitch of the DOE 110 may vary so that the DOE 110 operates as an optical lens having a positive, i.e. focusing, optical power. In some embodiments, the DOE 110 may be configured to form a real or virtual image at some distance from the DOE 110. In some embodiments, the DOE 110 may be configured to form an image at or near an eyebox 140. In some embodiments, the pitch of the DOE 110 may spatially vary so that the edge rays 151, 153 of the image light 150, upon in-coupling into the substrate 125, propagate along converging directions. The ODG 130, which may have a constant, i.e. spatially uniform grating pitch, is configured to diffract laterally offset portions of image light 150 incident thereon out of the substrate 125 toward the eyebox 140. In an example embodiment, the grating pitch of the ODG 130 may be selected e.g. to diffract a central ray 152 of the image light 150 in a direction perpendicular to the surfaces 121, 122. The DOE 110 may cooperate with the ODG 130 so that after a first diffraction from the ODG 130, the edge rays 151, 153 of the image light 150 converge at a “focus” location 141, defining a FOV 166 of the display apparatus 100.

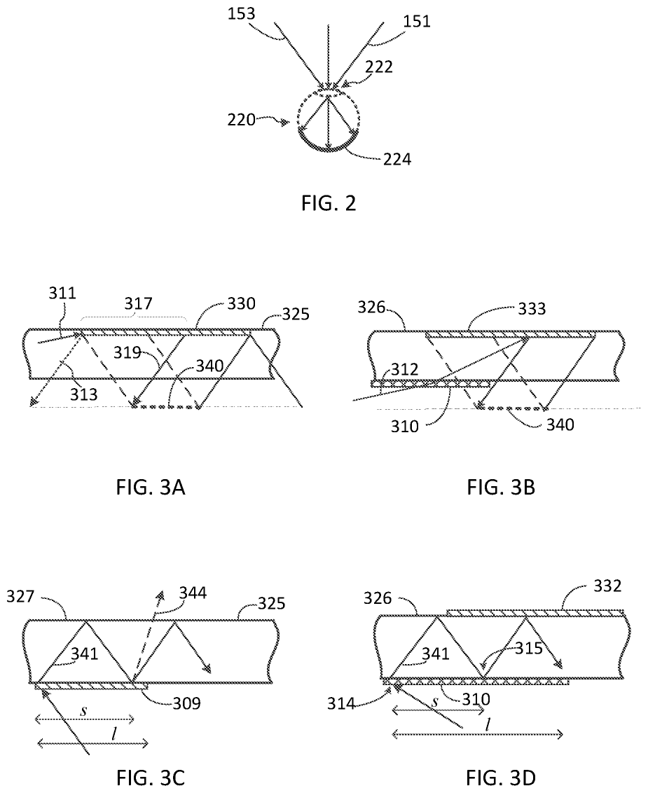

In some embodiments, the display apparatus 100 may be configured to project at least a fraction of the image light 150 through a pupil 222 of a user's eye 220, as illustrated in FIG. 2. In this configuration, the image is projected directly onto the retina 224 of the eye substantially independently on the accommodation response of the eye, i.e. the state of the eye's crystalline lens. Being substantially focus-invariant, such embodiments can alleviate the vergence-accommodation conflict (VAC) of a human eye compared to conventional lightguide-based NEDs that project image light onto a plane. In some embodiments of the display apparatus 100, the “focus” location 144 may be within or near the eyebox 140. In some embodiments, additional focusing and/or phase-front correcting optics (not shown) may be provided between the eyebox 140 and the lightguide 120.

Referring back to FIG. 1, non-diffracted portions of the in-coupled image light, e.g. of the rays 151 and 153, propagate within the substrate 125 along a zig-zag path. Further fractions of the in-coupled image light 150 undergo successive diffractions out of the substrate 12, either at each incidence on the ODG 130 or at every other incidence thereon, depending on a position of the ODG 130 upon or within the substrate 125. The effect of these successive diffractions is to replicate, approximately, the FOV 166 to a sequence of different pupil locations within or near the eyebox 140, e.g. 142 and 143, for viewing the images from different positions of the eye of the user within the eyebox 140.

When observed in the z-axis direction normal to the surfaces 121, 122, the DOE 110 may at least partially overlap with both the ODG 130 (as indicated at 132) and the eyebox 140, allowing for a more compact and efficient configuration. The DOE 110 may be configured to operate as an off-axis optical lens, so that the image projector 103 may be positioned outside of the FOV 166 for any viewing location within the eyebox 140. The term “off-axis” maybe used here to refer to an optical lens that is configured for off-axis incidence, i.e. to redirect, focus, defocus, collimate, etc. off-axis light beams.

The DOE 110 may further be configured to have a suitably narrow angular bandwidth of diffraction outside the angular acceptance range 155, so as to allow rays of the in-coupled image light 150, which impinge upon subsequent locations at the DOE 110 at corresponding angles of TIR, to be reflected from the substrate surface 121 substantially without being affected by the DOE 110.

In some embodiments, the DOE 110 may have a spatially varying angular bandwidth of diffraction, i.e. the range of angles of incidence outside of which the diffraction efficiency of the DOE 110 is suitably small. In some embodiments, the DOE 110 may be configured so that a ray of the image light that is in-coupled by the DOE 110 at a first location thereon, propagates within the substrate at a TIR angle that is outside of the local diffraction bandwidth at the locations of subsequent incidences. The local diffraction bandwidth may depend on at least one of the local grating pitch or a local tilt angle of diffractive fringes or grooves.

FIGS. 3A to 3D illustrate the origins of higher optical throughput, or output efficiency, of a pupil-replicating lightguide with an imaging in-coupler having a spatially-varying grating pitch and/or slant, such as e.g. the DOE 110. FIGS. 3A and 3B schematically illustrate image light propagation in output portions of respective substrates 325 and 326 when using a conventional constant-pitch grating in-coupler (FIG. 3A) and a variable-pitch DOE configured to focus or project the image light to a small area of an eyebox 340 (FIG. 3B). In each case, the respective lightguide may include an ODG, 330 or 333, which extends across a display FOV when viewed from edge points of the respective eyebox 340.

In the case of the conventional lightguide of FIG. 3A, some rays of the in-coupled image light, e.g. a FOV edge ray 311, has to propagate along a length 317 of the ODG 330, before a diffraction from the ODG 330 may direct the diffracted light, e.g. 319, toward the eyebox 340. While propagating along the ODG length 317, ray 311 may experience a number of “wasteful” diffractions, e.g. as illustrated by a diffracted ray 313, with the diffracted light missing the eyebox 340, which reduces the throughput efficiency of the lightguide. In contradistinction, a variable-pitch in-coupling DOE 310 of FIG. 3B may be configured to project each ray of the in-coupled light, e.g. ray 312, to a location at the corresponding ODG 333 from which the diffracted portion of the ray can reach the eyebox 340, thereby enhancing the output efficiency of the lightguide.

The input portions of the substrates 325 and 326 are illustrated in FIGS. 3C and 3D, respectively. A conventional constant-pitch grating in-coupler 309 is shown in FIG. 3C. A variable-pitch DOE 310 configured as described above with reference to DOE 110 is shown in FIG. 3D. In the embodiment of FIG. 3C, a fraction of in-coupled light 341 may be diffracted out of the substrate 325 by the in-coupler 309, e.g. as illustrated at 344, if the length l of the in-coupler 309 along the path of the diffracted light exceeds the zig-zag step s of the optical path of the in-coupled light 341 within the substrate 325, i.e. the distance between consecutive TIR bounces off a same outer surface of the substrate 325. In the embodiment of FIG. 3D, the grating pitch and/or the tilt or slant of grating fringes of the DOE 310 may vary along the propagation path of the in-coupled light 341, thereby also changing its diffraction angular bandwidth, so that at subsequent “bounce” locations 315 the DOE 310 no longer can substantially diffract the in-coupled light 341. For example, the diffraction efficiency of the DOE 310 at locations 315 of subsequent in-coupled light incidences may be at least 10 times smaller, or at least 20 times smaller, or in some embodiments at least 40 times smaller than at the location 314 of the in-coupling. Accordingly, the length l of the in-coupler, e.g. the DOE 310, may be increased without substantially increasing the optical loss in the lightguide, thereby potentially allowing to couple more image light into the substrate, or to increase an input FOV of the lightguide.

In some embodiments, the DOE 110 of FIG. 1 or the DOE 310 of FIG. 3 may be a holographic optical element (HOE), e.g. a freeform HOE, configured to re-direct the image light 150 in the off-axis configuration to couple into the substrate 125 within the angular range of TIR. An HOE may be configured to redirect light beams propagating within a specific range of ray angles, to perform a desired function of focusing, collimation, aberration correction, and the like. Freeform HOEs can be constructed with a great degree of flexibility, enabling the redirection of light rays at large angles of incidence while correcting for aberrations of these highly oblique rays. A freeform HOE may be configured to provide high numerical aperture collimation or focusing with low aberrations in a very compact footprint. Herein, the term “freeform” refers to an element having no translational or rotational symmetry about axes normal to the mean plane of the element. A freeform HOE may be configured to operate in an off-axis geometry, i.e. to redirect, focus, defocus, collimate, etc. off-axis light beams. A HOE, e.g. a freeform HOE, may be fabricated, for example, by exposing a photopolymer disposed upon a substrate, e.g. surface 121 of substrate 125, to an interference pattern of suitably arranged reference and object beams.

Turning briefly back to FIG. 1, the image projector 103 may be embodied, for example, using a pixelated display panel, e.g. a liquid crystal (LC) micro display, optionally having suitable optics at its output. It may also be embodied using a light source, such as e.g. one or more light-emitting diodes (LED), superluminescent light-emitting diodes (SLED), side-emitting laser diodes, vertical-cavity surface-emitting laser diodes (VCSEL), etc., optically coupled to an image beam scanner. In some embodiments the image projector 103 may include polarization sensitive elements such as e.g. polarizers and waveplate, to output the image light in a desired state of polarization.

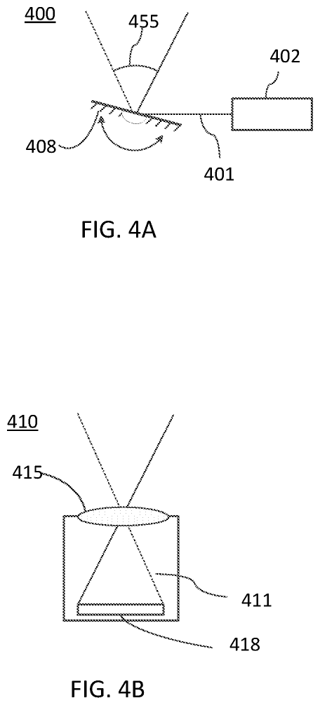

FIG. 4A schematically illustrates a scanning image projector 400, which includes a light source 402 and one or more scanning reflectors 408, such as e.g. one or more tilting mirrors. The light source 402 may include one or more point sources of coherent or incoherent light, such as e.g. semiconductor lasers or light-emitting diodes, and means to modulate their light output. The scanning projector 400 may further include focusing and/or collimating optics (not shown). The scanning projector 400 may be configured to generate image frames by angularly scanning the beam 401 of modulated image light in 2D, e.g. using the one or more scanning reflectors 408, across the input FOV455, responsive to signals from an image processor (not shown). The beam 401 may be provided by the one or more point light sources 402, which may also be controlled by the image processor in dependence on the image content of the frame being displayed. The scanning projector 400 may be used as the image projector 103 in some embodiments of the display apparatus 100 of FIG. 1, e.g. those wherein the DOE 110 includes a HOE.

In some embodiments, the image projector 103 may be a pixelated image projector 410 that includes a display panel 418, as schematically illustrated in FIG. 4B. The display panel 418 is configured to emits image light 411, and may be followed by focusing or collimating optics 415. In some embodiments, a spatial light modulator (SLM) operating in either transmission or reflection and followed by suitable focusing and/or collimating optics may be used to implement the image projector 103.

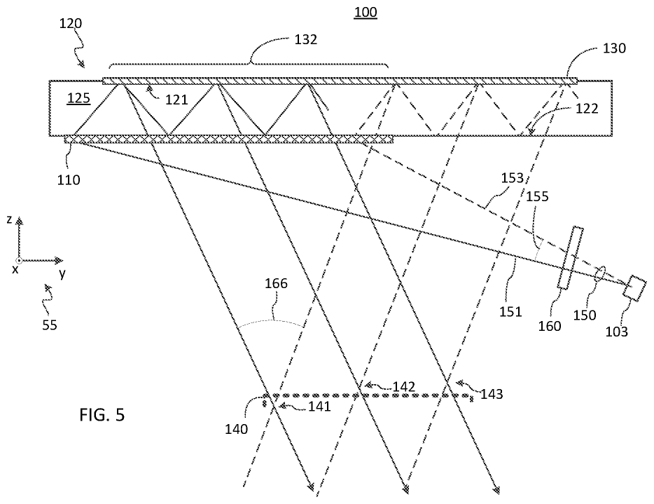

One complication of using a variable-pitch DOE as an in-coupler of a lightguide is that the replicated output “focal points” of the image light, e.g. 141-143, may be at different distances from the lightguide, as schematically illustrated in FIG. 1. Different rays of the image beam may not converge to a same focal point at the eyebox, converging instead to some “focal volume”. Furthermore, the image projector 103 may have an exit pupil of a finite size, so that e.g. each of the rays 151 and 153 represent a collimated sub-beam of the image light 150 having a finite beam size. These sub-beams may no longer be collimated after being in-coupled after diffraction by the DOE 110. Referring to FIG. 5, some embodiments of the display apparatus 100 may include pre-compensation optics 160 between the image projector 103 and the DOE 110, configured to suitably modify the wavefront of the image light 150 so as to pre-compensate for at least some of the optical distortions related to the DOE 110 and the light propagation in the substrate 125. In some embodiments, the pre-compensation optics 160 may include a suitably configured SLM. In some embodiments, the pre-compensation optics 160 may include two or more suitably shaped refractive lens elements. In some embodiments, the pre-compensation optics 160 may be configured so that portions or sub-beams of the image light 150 that are collimated at the output of the image projector 103 remain substantially collimated after being in-coupled by the DOE 110. One skilled in the pertinent art, having the benefit of the present disclosure, will be able to arrive at a suitable design of the pre-compensation optics 160.

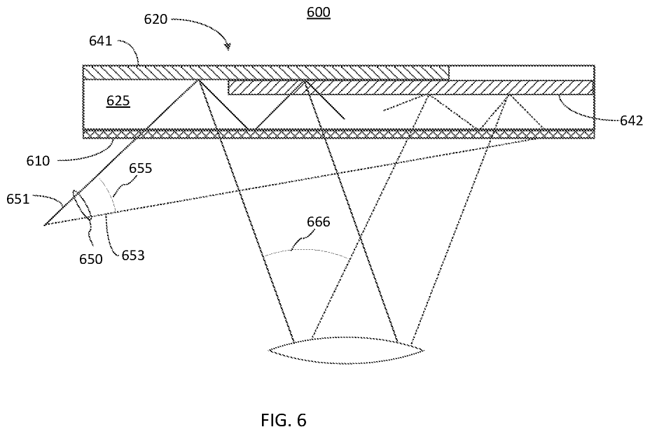

FIG. 6 illustrates a display apparatus 600 having a lightguide 620 comprising a substrate 625 and an in-coupler including a DOE 610. The DOE 610 has a spatially-varying pitch and is configured for off-axis operation, generally as described above with reference to DOE 110. The substrate 625 may be an embodiment of the substrate 125 of FIG. 1. The lightguide 620 (FIG. 6) may be substantially like the lightguide 120 (FIG. 1) but with an out-coupler including two ODGs, 641 and 642, which may or may not have overlapping portions. The ODGs 641 and 642 are configured to diffract rays of the in-coupled image light 650 having different angles of incidence upon the substrate, e.g. as illustrated in FIG. 6 for the FOV edge rays 651 and 653. The ODGs 641 and 642 may be configured to diffract incident light in a same plane, e.g. the plane of FIG. 6. The ODGs 641 and 642 may be further configured to diffract rays of in-coupled image light 650 rays in different directions along the substrate 625, e.g. operating in different diffraction modes. For example, ODG 641 may be configured to predominantly diffract incident rays of the image light 650 in a (+1) diffraction order, while ODG 642 may be configured to predominantly diffract incident rays of the image light 650 in a (−1) diffraction order. In some embodiments, the ODGs 641 and 642 may be formed as slanted surface-relief diffraction gratings with their respective grating grooves having opposite slant angles. Having an out coupler with two or more ODGs may allow angular FOV multiplexing to broaden the FOV 666 of the display. With the two output gratings, the DOE 610 may be configured to have a wider angular acceptance range 755 than DOE 110 of the display apparatus 100 of FIG. 1. In some embodiments, the lightguide may have an out-coupler including more than two ODGs, at least some of which having substantially parallel grooves. In some embodiments, the ODGs may be ON-OFF switchable, e.g. in dependence on a current angle of incidence of a scanning image beam.

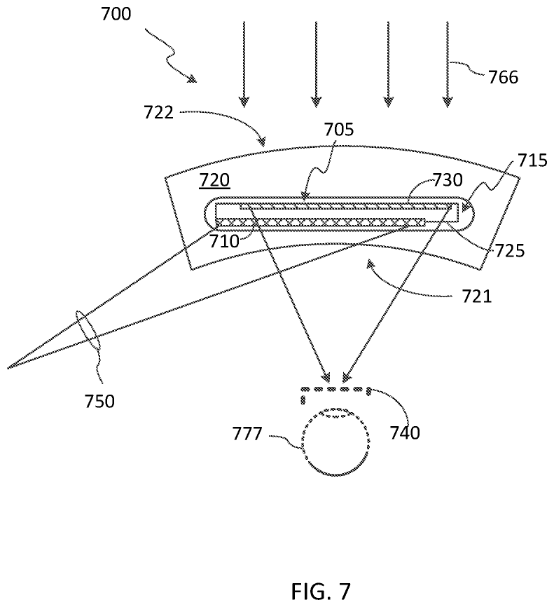

Referring to FIG. 7, a display apparatus 700 has a lightguide 705 imbedded into a curved shell substrate 720 of optically transparent material or materials. The lightguide 705 includes a substrate 725, a DOE 710, and an ODG 730. The lightguide 705 may be an embodiment of the lightguide 120 of FIG. 1 or lightguide 620 of FIG. 6, with the DOE 710 being an embodiment of the DOE 110 or 610, and an ODG 730 being an embodiment of the ODG 130 or the ODGs 641 and 642. The lightguide 705 may be disposed in a cavity 715 within the curved shell substrate 720 with airgaps at the main surfaces thereof to allow for TIR. In some embodiments the airgaps may be vacuum gaps, or may be filled with a suitable gas or generally any suitable optically transparent material having a substantially lower index of refraction than that of the substrate 725. A first portion 721 of the curved shell substrate 720 faces a viewing area 740 where an eye 777 of the viewer may be located. This first portion 721 may be configured, e.g. shaped, to function as a lens, i.e. to have an optical power, so as to suitably focus or de-focus the image light 750. In some embodiments, the eye-facing portion 721 may be configured to cooperate with the DOE 710 to focus the image light 750 to a location at a target distance from the lightguide 705. In some embodiments, the eye-facing portion 721 may be configured to cooperate with the DOE 710 to focus or de-focus the image light 750 to form a virtual image at a desired distance from the viewing area 740, e.g. at about two feet from a human eye for comfortable viewing.

In some embodiments, the display apparatus 700 may be configured to operate as an augmented reality (AR) display, e.g. an AR NED, to combine for a viewer the outside scenery carried by ambient light 766 with images carried by image light 750. In such embodiments, a second portion 722 of the curved shell substrate 720, which is distal from the eyebox 740 and faces the outside scenery when in use, may be also shaped to have an optical power, e.g. to at least partially compensate the optical power of the first portion 721. In some embodiments, the two portions 721, 722 of the curved shell substrate 720 may cooperate to have a target optical power, e.g. to function as a prescription lens, or to have a zero optical power.

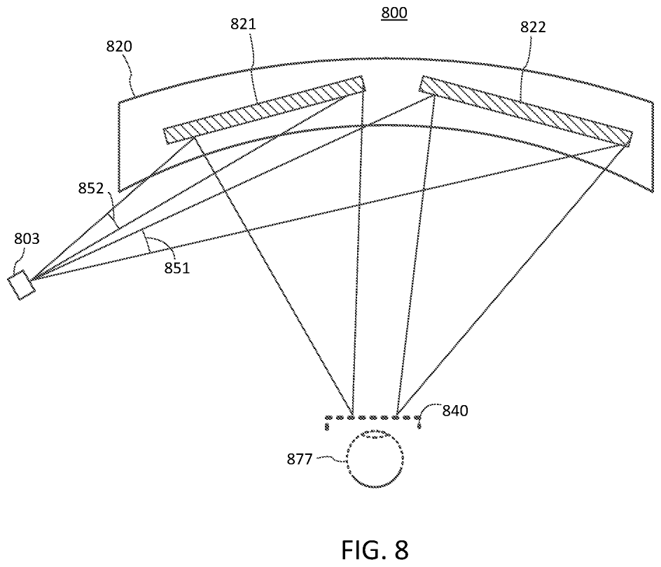

In some embodiments, two or more slab lightguides may be disposed within a same curved optically transparent shell substrate, with their orientation generally following the curvature of the shell substrate. Referring to FIG. 8 for a non-limiting illustrative example, a display 800 includes a curved shell substrate 820 incorporating two planar slab lightguides 821 and 822 disposed at an angle to each other, generally following the curvature of the shell substrate as shown. Each of the slab lightguides 821 and 822 may be an embodiment of the lightguide 705, the lightguide 120, or the lightguide 620, and may include a DOE with a spatially-variable pitch as an in-coupler and an ODG with a uniform pitch as an out-coupler. Each of the lightguides 821 and 822 may receive, e.g. from a same source of image light 803, different FOV portions of image light, indicated at 851 and 852, and convey said FOV portions to a same location or locations in an eyebox 840, to be integrated by a viewer's eye in a single image. In this manner, the lightguides 821 and 822 may receive different images from a common projector.

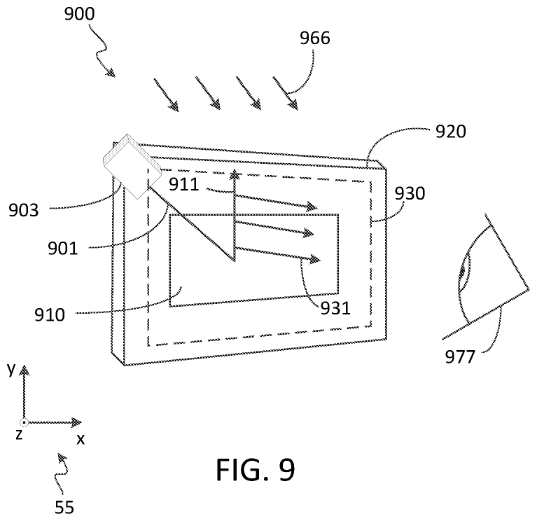

FIG. 9 illustrates an example lightguide 920 in a vertical orientation relative to the ground, i.e. as it may be oriented in use as part of an AR NED 900 when worn in front of, and near to, an eye of a user. The lightguide 920, which may be an embodiment of any of the waveguides described above, includes an in-coupling DOE 910, which in turn may be an embodiment of any of the DOEs described above. In operation the DOE 910 receives image light 901 from an image projector 903, couples it into the lightguide 920 to propagate therein as in-coupled light 911. An out-coupling ODG 930 re-directs the in-coupled light 911 out of the lightguide toward an eye 977 of the user as output image light 931. The NED 900 may be configured as an AR display, with the lightguide 920 being optically transparent for ambient light and in operation combining for the user the output image light 931 with ambient light 966. The ambient light 966, in particular sunlight, may experience diffraction upon the ODG 930, potentially leading to a so-called rainbow artifact for the user when the diffracted ambient light is within the FOV of the user's eye 977. The rainbow artifact may be reduced or eliminated in a display configuration where in-coupled light 911 and the ambient light 966 propagate in opposite directions. Since the ambient illumination is expected to come from above, e.g. the sun, and thus directed mostly downwards toward the ground, positioning the image projector 903 generally above the DOE 310 may be expected to reduce the rainbow effect in a range of normal operating conditions.

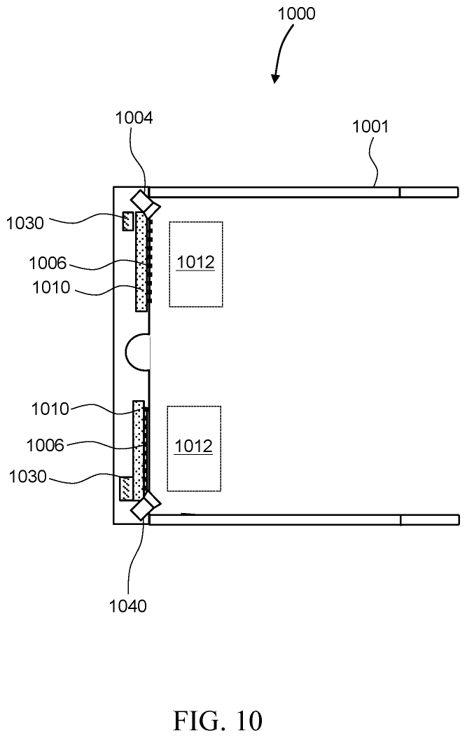

Referring to FIG. 10, an augmented reality (AR) near-eye display (NED) 1000 includes a frame 1001 supporting, for each eye: an image projector 1030, e.g. the scanning projector 400 of FIG. 4A or the display-panel based projector 410 of FIG. 4B; a lightguide 1010 including a DOE with a spatially variable pitch as described above with reference to FIG. 1, FIGS. 5-9 etc., for relaying image light generated by the image projector 1030 to one or more locations in the eyebox 1012 where the eye is detected. A plurality of eyebox illuminators 1006, shown as black dots, may be placed around the lightguide 1010 on a surface that faces the eyebox 1012. An eye-tracking camera 1004 may be provided for each eyebox 1012.

The purpose of the eye-tracking cameras 1004 is to determine position and/or orientation of both eyes of the user. The eyebox illuminators 1006 illuminate the eyes at the corresponding eyeboxes 1012, allowing the eye-tracking cameras 1004 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1006, the latter may be made to emit light invisible to the user. For example, infrared light may be used to illuminate the eyeboxes 1012.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

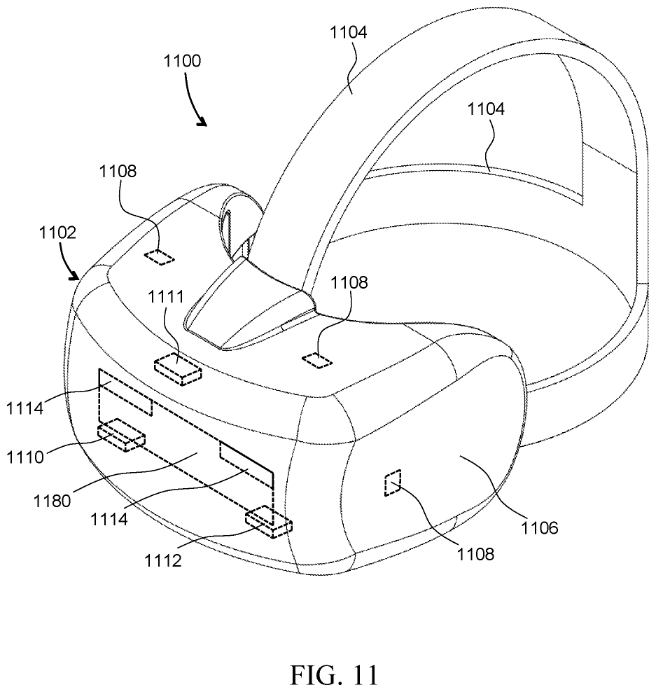

Turning to FIG. 11, an HMD 1100 is an example of an AR/VR wearable display system which encloses the user's face, for a greater degree of immersion into the AR/VR environment. The HMD 1100 may generate the entirely virtual 3D imagery. The HMD 1100 may include a front body 1102 and a band 1104 that can be secured around the user's head. The front body 1102 is configured for placement in front of eyes of a user in a reliable and comfortable manner. A display system 1180 may be disposed in the front body 1102 for presenting AR/VR imagery to the user. The display system 1180 may include any of the display devices, lightguides, and tunable segmented diffraction gratings disclosed herein. Sides 1106 of the front body 1102 may be opaque or transparent.

In some embodiments, the front body 1102 includes locators 1108 and an inertial measurement unit (IMU) 1110 for tracking acceleration of the HMD 1100, and position sensors 1112 for tracking position of the HMD 1100. The IMU 1110 is an electronic device that generates data indicating a position of the HMD 1100 based on measurement signals received from one or more of position sensors 1112, which generate one or more measurement signals in response to motion of the HMD 1100. Examples of position sensors 1112 include: one or more accelerometers, one or more gyroscopes, one or more magnetometers, another suitable type of sensor that detects motion, a type of sensor used for error correction of the IMU 1110, or some combination thereof. The position sensors 1112 may be located external to the IMU 1110, internal to the IMU 1110, or some combination thereof.

The locators 1108 are traced by an external imaging device of a virtual reality system, such that the virtual reality system can track the location and orientation of the entire HMD 1100. Information generated by the IMU 1110 and the position sensors 1112 may be compared with the position and orientation obtained by tracking the locators 1108, for improved tracking accuracy of position and orientation of the HMD 1100. Accurate position and orientation is important for presenting appropriate virtual scenery to the user as the latter moves and turns in 3D space.

The HMD 1100 may further include a depth camera assembly (DCA) 1111, which captures data describing depth information of a local area surrounding some or all of the HMD 1100. The depth information may be compared with the information from the IMU 1110, for better accuracy of determination of position and orientation of the HMD 1100 in 3D space.

The HMD 1100 may further include an eye tracking system 1114 for determining orientation and position of user's eyes in real time. The obtained position and orientation of the eyes also allows the HMD 1100 to determine the gaze direction of the user and to adjust the image generated by the display system 1180 accordingly. The determined gaze direction and vergence angle may be used to adjust the display system 1180 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1102.

Display embodiments described above are intended to be merely non-limiting illustrative examples. Many variations and modifications are possible. For instance, monochromatic or polychromatic image light may be used. For color images, the image light of different color channels may be spatially and/or temporally multiplexed. Two or more stacked lightguides may be used to guide different color channels. The grating pitch of the input and/or output couplers of the same lightguide may be tuned to accommodate different color channels in a time multiplexed manner. More than one diffraction grating with parallel or non-parallel grating vectors may be used to couple light out of the lightguide. Some embodiments may utilize more than one input DOE and/or more than one ODGs, e.g. to support a 2D FOV. When two or more diffraction gratings are used for the out-coupling, the gratings may be superimposed to form a 2D grating structure, e.g. at a same outer surface of the lightguide's substrate. In some embodiments, different in-coupling gratings or different out-coupling gratings may be disposed at the opposite outer surfaces of the substrate. Embodiments in which one or more input DOEs or one or more output gratings are disposed in the bulk of the substrate are also within the scope of the present disclosure.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A lightguide for a display apparatus, the lightguide comprising:
a substrate for relaying image light to an eyebox;
an input diffractive optical element (DOE) configured to couple the image light into the substrate, the input DOE having a spatially variable pitch to provide the DOE with an optical power; and
a grating out-coupler supported by the substrate for out-coupling portions of the image light from the substrate toward the eyebox.

2. The lightguide of claim 1 wherein the substrate comprises two opposing surfaces for guiding the image light within the substrate by total internal reflection (TIR) from the surfaces.

3. The lightguide of claim 2 wherein the input DOE comprises a holographic optical element (HOE) having a positive optical power.

4. The lightguide of claim 3 wherein the HOE is configured to operate as a focusing lens.

5. The lightguide of claim 3 wherein the HOE is configured to operate as an off-axis lens.

6. The lightguide of claim 3 wherein the HOE is configured to transmit therethrough, substantially without diffraction, light incident thereon at angles outside an angular acceptance range of the input DOE.

7. The lightguide of claim 6 wherein the input DOE is disposed at one of the two opposing surfaces, and is configured so as not to diffract rays of in-coupled image light that are incident thereon after a TIR at the other one of the two opposing surfaces.

8. The lightguide of claim 6 wherein the angular acceptance range of the input DOE is outside of an angular range of TIR at the opposing surfaces of the substrate.

9. The lightguide of claim 2 wherein the input DOE has a positive optical power, and wherein the grating out-coupler comprises a first optical diffraction grating (ODG).

10. The lightguide of claim 9 wherein the input DOE and the first ODG are disposed along the two opposing surfaces with an overlap.

11. The lightguide of claim 9 wherein the first ODG has a constant grating pitch.

12. The lightguide of claim 9 wherein the grating out-coupler comprises a second ODG, the first and second ODGs having opposite slant angles.

13. A display apparatus comprising:
a first lightguide comprising a substrate for relaying image light to a viewing area;
an input diffractive optical element (DOE) configured to couple the image light into the lightguide, the input DOE having a spatially variable pitch to provide the DOE with a positive optical power; and
a grating out-coupler supported by the substrate for out-coupling the image light from the substrate toward the viewing area.

14. The display apparatus of claim 13 comprising a curved shell substrate of an optically transparent material, the curved shell substrate comprising the first lightguide including the input DOE and the grating out-coupler.

15. The display apparatus of claim 14 wherein the first lightguide is disposed in a cavity within the curved shell substrate with gaps between opposing surfaces of the substrate and the material of the shell.

16. The display apparatus of claim 14 comprising a second lightguide disposed within the curved shell substrate and comprising a substrate, an input DOE, and a diffractive out-coupler, wherein the substrates of the first and second lightguides are an angle to each other.

17. The display apparatus of claim 13 comprising an image projector for directing the image light toward the input DOE, the image projector disposed at a top portion of the substrate when the display apparatus is in use by a standing person.

18. The display apparatus of claim 13 wherein the grating out-coupler comprises a diffraction grating having a substantially constant grating pitch.

19. A lightguide for a display apparatus, the lightguide comprising:
a substrate for relaying image light to an eyebox;
an input diffractive optical element (DOE) configured to couple the image light into the substrate, the input DOE having a spatially variable pitch; and
a diffractive out-coupler supported by the substrate for out-coupling portions of the image light from the substrate toward the eyebox, the diffractive out-coupler comprising an optical diffraction grating having a substantially constant grating pitch.

20. The lightguide of claim 19 wherein the input DOE is configured to have a positive optical power.
